(19) United States
(12) Patent Application Publication
(10) Pub. No.: US 2016/0182989 A1
(43) Pub. Date: Jun. 23, 2016

(54) ALL-IN-ONE DEVICE

(71) Applicant: Samsung Display Co., Ltd., Yongin City (KR)

(72) Inventors: Myungim KIM, Yongin-si (KR); Wonsang PARK, Yongin-si (KR); Yijoon AHN, Seoul (KR); Sukman YANG, Seoul (KR); Yong-suk YEO, Seongnam-si (KR); Taehee LEE, Gumi-si (KR)

(21) Appl. No.: 14/817,982

(22) Filed: Aug. 4, 2015

(30) Foreign Application Priority Data
Dec. 18, 2014 (KR) 10-2014-0183235

(51) Int. Cl. H04R 1/06; H04R 7/02

(52) U.S. Cl. CPC H04R 1/06; H04R 7/02; H04R 2499/11

(57) ABSTRACT

Provided is an all-in-one device. The all-in-one device has first, second and third regions that can perform different functions. The all-in-one device includes an upper electrode disposed in each of the first through third regions, a lower electrode disposed in each of the first through third regions to face the upper electrode, a first diaphragm disposed in each of the first through third regions and positioned between the upper electrode and the lower electrode, a first spacer disposed in at least two of the first through third regions to electrically insulate the first diaphragm from the upper electrode, second spacers respectively disposed in the second and third regions, the second spacers each disposed on the lower electrode, and diaphragm electrodes disposed in the second and third regions between the respective second spacers and the first diaphragm.

### CROSS-REFERENCE TO RELATED APPLICATIONS

This U.S. non-provisional patent application claims priority under 35 U.S.C. §119 to Korean Patent Application No. 10-2014-0183235 filed on Dec. 18, 2014, the entire contents of which are hereby incorporated by reference.

### BACKGROUND

Current all-in-one devices have the functions of a speaker, microphone, and ultrasonic sensor.

The original purpose of mobile communication devices was to provide audio communication between two individuals who are far away from each other. Thus, there was only a receiver which was closely attached to an ear of the user to generate a relatively low acoustic pressure. A speaker for generating a high acoustic pressure so that the sound can be heard from a distance away was unnecessary.

In recent years, various functions of the mobile communication terminal are converging. As internal and external flash memories of the mobile terminal increase in capacity, music and video playing functions, e.g., playing an MP3 or AVI file and watching TV, can be supported. Now, mobile terminals are increasingly being used as portable multimedia devices instead of being used in their traditional roles as voice or text communication mechanisms.

When making a voice call, use of a receiver is often cumbersome and inconvenient even when there is no one around, and also, when the multimedia function is used, consumers often desire a loud speaker, i.e., an external speaker for hearing and watching of the sound and video. Therefore, configurations exist in which a receiver has been attached to a mobile terminal together with a loud speaker. However, since a plurality of diaphragms have to be built-in, miniaturization of the device is challenging.

### SUMMARY

Embodiments of the present disclosure provide an all-in-one device that is capable of realizing a plurality of functions to allow for smaller, more compact electronic devices.

Embodiments of the inventive concept provide all-in-one devices partitioned into first, second and third regions capable of performing functions different from each other. Such all-in-one devices include: an upper electrode disposed in each of the first, second and third regions; a lower electrode disposed in each of the first, second and third regions to face the upper electrode; a first diaphragm disposed in each of the first, second and third regions and positioned between the upper electrode and the lower electrode; a first spacer disposed in at least two of the first, second and third regions to electrically insulate the first diaphragm from the upper electrode; second spacers respectively disposed in the second and third regions, the second spacers being each disposed on the lower electrode; and diaphragm electrodes respectively disposed in the second and third regions and disposed between the respective second spacers and the first diaphragm.

In some embodiments, a first distance from the first diaphragm to the upper or lower electrode in the first region may be greater than a second distance from the first diaphragm to the upper or lower electrode in the second or third region.

In other embodiments, the upper or lower electrode in the first region may have a thickness less than that of its thickness in the second and third regions.

In still other embodiments, the first region may be a region configured to generate sound waves, and each of the second and third regions may be configured to generate corresponding electrical signals from received sound waves.

In even other embodiments, each of the upper and lower electrodes may include a plurality of through-holes in each of its first through third regions, the through-holes configured for receiving or emitting the sound waves.

In yet other embodiments, the first region may be configured to generate both sound waves and ultrasonic waves, and the second region may be configured to generate corresponding electrical signals from received sound waves, and the third region may be configured to generate corresponding electrical signals from received ultrasonic waves.

In further embodiments, the upper electrode in the first to third region may include a first plurality of through-holes configured to pass at least one of sound waves and ultrasonic waves therethrough.

In still further embodiments, the lower electrode in the first and second regions may include a second plurality of through-holes, and the lower electrode in the third region may include a plurality of grooves.

In even further embodiments, the first diaphragm may be partitioned into a first part in the first region and a second part in the second and third regions, and the first and second parts may comprise different materials. The different materials may have material properties different from each other.

In yet further embodiments, the second part may be coated with diamond-shaped carbon or metal.

In much further embodiments, the first region may be configured to generate sound waves, and each of the second and third regions may be configured to generate corresponding electrical signals from received sound waves.

In still much further embodiments, each of the upper and lower electrodes may include a plurality of through-holes in each of the first through third regions, the through-holes sized for passing sound waves therethrough.

In even much further embodiments, the first region may be configured to generate both sound waves and ultrasonic waves, the second region may be configured to generate corresponding electrical signals from received sound waves, and the third region may be configured to generate corresponding electrical signals from received ultrasonic waves.

In yet much further embodiments, the upper electrode may include a plurality of through-holes in each of the first through third regions, the through-holes sized for passing sound waves and ultrasonic waves therethrough.

In some embodiments, the lower electrode may include a plurality of through-holes in the first and second regions, and the lower electrode may include a plurality of grooves formed in the third region.

In other embodiments, the all-in-one devices may further include second diaphragms disposed on the second spacers and respectively disposed in the second and third regions.

In still other embodiments, the first diaphragm may have opposing ends respectively disposed on the diaphragm electrodes.

In even other embodiments, the first diaphragm and each of the second diaphragms may have elastic coefficients different from each other.

In yet other embodiments, the first diaphragm may have the elastic coefficient less than that of the second diaphragm.

In further embodiments, the upper electrode may include a first plurality of through-holes sized for passing sound waves or ultrasonic waves therethrough.

In still further embodiments, the lower electrode may include a second plurality of through-holes positioned in each of the first through third regions, and the lower electrode in the third region may include a plurality of grooves.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. The drawings are not necessarily to scale. In the drawings:

FIG. 1A is a perspective view of an all-in-one device according to a first embodiment;

FIG. 1B is a cross-sectional view of the all-in-one device of FIG. 1A;

FIG. 2 is a schematic block diagram of a driving part for driving the all-in-one device of FIGS. 1A and 1B;

FIG. 3A is a perspective view of an all-in-one device according to a second embodiment;

FIG. 3B is a cross-sectional view of the all-in-one device of FIG. 3A;

FIG. 4A is a perspective view of an all-in-one device according to a third embodiment;

FIG. 4B is a cross-sectional view of the all-in-one device of FIG. 4A; and

FIG. 5 is a front view of an electronic device including the all-in-one device.

### DETAILED DESCRIPTION OF THE EMBODIMENTS

For the terms used in the present disclosure, general terms widely currently used have been selected as possible as they can. In a specific case, terms arbitrarily selected by an applicant may be used. In this case, since the meaning thereof is described in detail in the detailed description of the specification, the present disclosure should be understood in an aspect of meaning of such terms, not the simple names of such terms.

Exemplary embodiments of the inventive concept will be described below in more detail with reference to the accompanying drawings. The inventive concept may, however, be embodied in different forms and should not be construed as limited to the embodiments set forth herein.

Hereinafter, exemplary embodiments of the inventive concept will be described in detail with reference to the accompanying drawings.

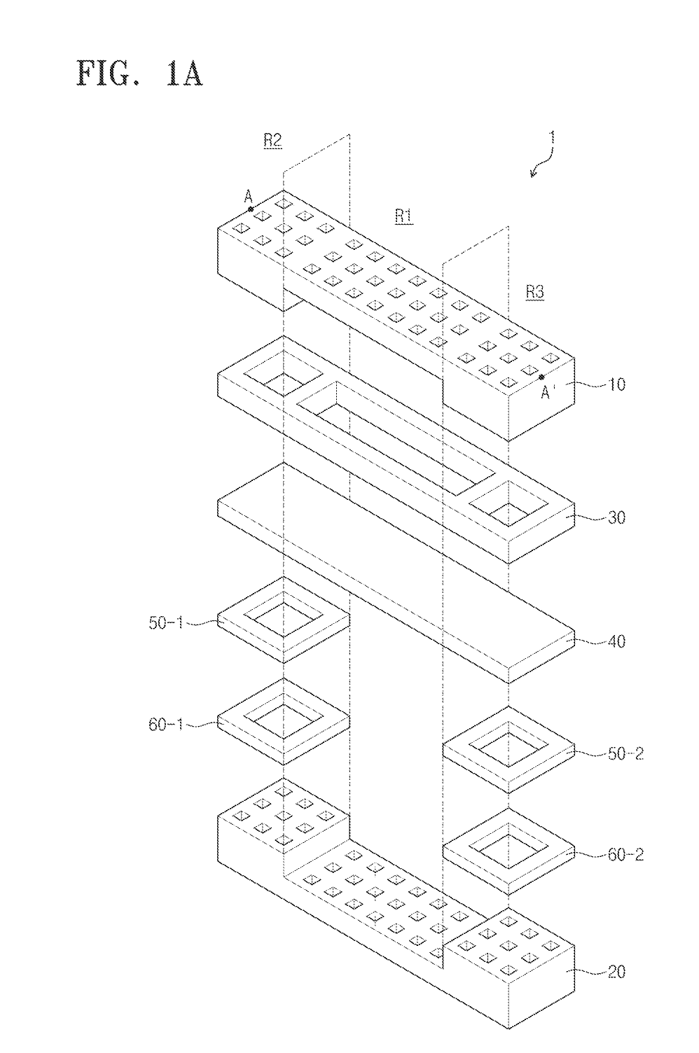

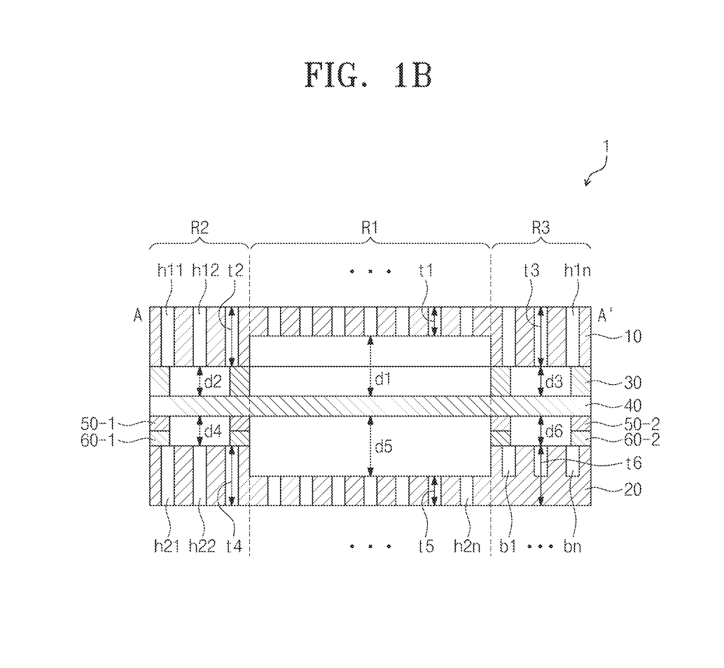

FIG. 1A is a perspective view of an all-in-one device according to a first embodiment. FIG. 1B is a cross-sectional view of the all-in-one device of FIG. 1A. In the present disclosure, the all-in-one device may represent an integrated device that is capable of performing a speaker, microphone, and/or ultrasonic wave function.

Referring to FIGS. 1A and 1B, the all-in-one device 1 may be partitioned into first to third regions R1 to R3 that are adjacent to each other. The second and third regions R2 and R3 may be regions adjacent to opposite sides of the first region R1.

Each of the first to third regions R1 to R3 may include an upper electrode 10, a lower electrode 20 facing the upper electrode 10, a first diaphragm 40 disposed between the upper and lower electrodes 10 and 20, and a first spacer 30 disposed between the first diaphragm 40 and the upper electrode 10.

The upper electrode 10 is disposed in each of the first to third regions R1 to R3 to form electric fields together with the lower electrode 20. The first diaphragm 40 disposed between the upper and lower electrodes 10 and 20, and may vibrate in response to the electric fields formed by the upper and lower electrodes 10 and 20. The upper and lower electrodes 10 and 20 may be formed by depositing a metal having conductivity, or applying conductive paint, on one surface of an insulating film such as, but not limited to, polyethylene terephthalate (PET) or polypropylene (PP).

The upper electrode 10 may include a plurality of through-holes h11 to h1n that extend completely through the electrode 10, i.e. from a front surface to a rear surface thereof. Thus, air and sound may pass through the upper electrode 10 via the through-holes h11 to h1n. The lower electrode 20 may include a plurality of through-holes h21 to h2n or a plurality of grooves b1 to bn for each partitioned region. Like the through-holes h11-h1n, through-holes h21-h2n extend completely through electrode 20. Thus, the air and sound may pass through a certain region of the lower electrode 20 in which the plurality of through-holes h21 to h2n are defined.

Each of the upper and lower electrodes 10 and 20 may have different thicknesses for each region. For example, the upper electrode 10 may have a thickness t1 in the first region R1, which is less than thicknesses t2 and t3 of the upper electrode 10 in the second and third regions R2 and R3, respectively. Also, the lower electrode 20 may have a thickness t5 in the first region R1 which is less than thicknesses t4 and t6 of the lower electrode 20 in the second and third regions R2 and R3, respectively. This is because each of the electrodes performs a different function in each region. More detailed descriptions with respect to the thicknesses of each of the upper and lower electrodes 10 and 20 will be described later.

The first diaphragm 40 may be disposed in each of the first to third regions R1 to R3. The first diaphragm 40 may be formed by depositing a metal having conductivity, or applying conductive paint, on both surfaces of a film formed of PET or PP.

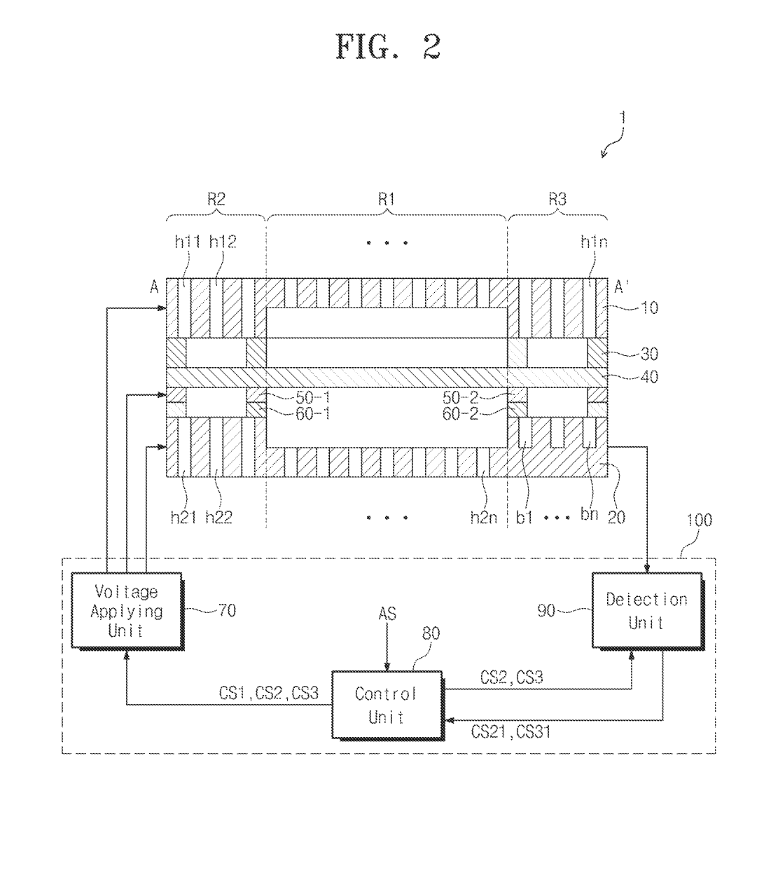

The first diaphragm 40 may vibrate by electric energy or sound energy for each function. In particular, the first diaphragm 40 may vibrate by electric energy or sound energy. For example, when the first diaphragm 40 functions as a speaker, the first diaphragm 40 may vibrate by electric energy. In this case, electric energy may be converted into sound energy by vibration of the first diaphragm 40. Or, when the first diaphragm 40 functions as a microphone or an ultrasonic sensor, the first diaphragm 40 may vibrate by sound energy. In this case, sound energy may be converted into electric energy by vibration of the first diaphragm 40, so that electrical signals are generated corresponding to received sound/ultrasound waves. Detailed descriptions with respect to the first diaphragm 40 are provided below with reference to FIG. 2.

The first spacer 30 may be disposed in each of the first to third regions R1 to R3 to insulate the first diaphragm 40 from the upper electrode 10. Thus, the first spacer 30 may be formed of an insulation material. Also, the first spacer 30 may have flexibility and thus be bent by external force. The first spacer 30 may have holes cut therein, so that the first diaphragm 40 vibrates.

The second and third regions R2 and R3 may further include a plurality of second spacers 60-1 and 60-2, and a plurality of diaphragm electrodes 50-1 and 50-2 positioned respectively corresponding to the second spacers 60-1 and 60-2.

The second spacers 60-1 and 60-2 may be respectively disposed in the second and third regions R2 and R3. The second spacers 60-1 and 60-2 may be disposed on the lower electrode 20. Also, the second spacers 60-1 and 60-2 may be respectively disposed on both ends of the lower electrode 20. The second spacers 60-1 and 60-2 may insulate the plurality of diaphragm electrodes 50-1 and 50-2 from the lower electrode 20. Thus, the second spacers 60-1 and 60-2 may be formed of an insulation material like the first spacer 30 and thus be flexible, i.e. able to be bent by an external force. Also, the second spacers 60-1 and 60-2 may have holes cut therein, so that the first diaphragm 40 vibrates.

The diaphragm electrodes 50-1 and 50-2 may be respectively disposed in the second and third regions R2 and R3. The diaphragm electrodes 50-1 and 50-2 may be disposed between the second spacers 60-1 and 60-2 and the first diaphragm 40. The diaphragm electrodes 50-1 and 50-2 may be disposed to respectively correspond to the second spacers 60-1 and 60-2. The diaphragm electrodes 50-1 and 50-2 may have holes cut therein like the first spacer 30 or second spacers 60-1 and 60-2. Each of the diaphragm electrodes 50-1 and 50-2 may apply a bias voltage to the first diaphragm 40 disposed thereon. Thus, each of the diaphragm electrodes 50-1 and 50-2 may be connected to a bias voltage terminal.

The first to third regions R1 to R3 may each perform functions different from each other in the all-in-one device 1.

According to an embodiment, the first region R1 may perform a sound wave output function (i.e. a device attached to device 1 may emit or transmit sound waves through region R1), and the second region R2 may perform a sound wave reception function (i.e., a device attached to device 1 may receive sound waves through region R2). Also, the third region R3 may perform an ultrasonic wave reception function (i.e., a device attached to device 1 may receive ultrasonic waves through region R3). To perform functions different from each other for each region, the upper and lower electrodes 10 and 20 commonly included in the first to third regions R1 to R3 may have structures different from each other for each region.

The diaphragm performing the sound wave output function may have average amplitude of vibration greater than that of the diaphragm performing the sound wave reception function or the ultrasonic wave reception function. Thus, it is necessary to secure a vibration space in the first region R1 performing the sound wave output function so that the first diaphragm 40 has sufficient clearance to vibrate. As a result, a first distance d1 or d5 between the first diaphragm 40 and the upper or lower electrodes 10 or 20 in the first region R1 may be greater than a second distance d2 or d4 between the first diaphragm 40 and the upper or lower electrodes 10 or 20 in the second region R2. Also, the first distance d1 or d5 may be greater than a second distance d3 or d6 between the first diaphragm 40 and the upper or lower electrode 10 or 20 in the third region R3.

For this, each of the upper and lower electrodes 10 and 20 may have thicknesses different from each other for each region. For example, the upper electrode 10 may have a thickness t1 in the first region R1 which is less than thicknesses t2 or t3 of the upper electrode 10 in the second or third regions R2 and R3. Similarly, the lower electrode 20 may have a thickness t5 in the first region R1 which is less than thicknesses t4 or t6 of the lower electrode 20 in the second or third regions R2 and R3.

For convenience of description, each the upper and lower electrodes 10 and 20 is shown in the drawings as having the same thickness in the second and third regions R2 and R3. However, the upper and lower electrodes 10 and 20 are not limited to having the same thickness. Thus, each of the upper and lower electrodes may have different thicknesses in the second and third regions R2 and R3. Also, within the same region, the distance from the first diaphragm 40 to the upper electrode 10 and the distance from the first diaphragm 40 to the lower electrode 20 may vary.

Also, the first region R1 may have a width greater than that of the second or third region R2 or R3. This is done for providing a sufficient space to allow the first diaphragm 40 to vibrate with greater amplitude in the first region R1 in comparison to the second or third region R2 or R3.

Although the lower electrode 20 includes a plurality of through-holes h21 to h2n passing from the front surface to the rear surface thereof in the first and second regions R1 and R2, the lower electrode 20 may include a plurality of grooves b1 to bn in the third region R3. Air or sound may pass through the lower electrode 20 in the first and second regions R1 and R2 through the plurality of through-holes h21 to h2n. Since the third region R3 does not include through-holes h21 to h2n, air or sound may not pass through the lower electrode 20 in the third region R3 and is instead reflected by the grooves b1 to bn. The third region R3 may detect the air or sound reflected by the grooves b1 to bn to perform an ultrasonic wave reception function.

According to another embodiment, the first region R1 may perform a sound wave output function, and each of the second and third regions R2 and R3 may perform a sound wave reception function (not shown). Thus, the first region R1 may output sound waves, and each of the second and third regions R2 and R3 may receive the sound waves.

In the current embodiment, to perform the sound wave output function or the sound wave reception function for each region, a first distance d1 or d5 from the first diaphragm 40 to the upper or lower electrodes 10 or 20 in the first region R1 may be greater than second distances d2 and d3 or d4 and d6 from the first diaphragm 40 to the upper or lower electrodes 10 or 20 in the second or third regions R2 or R3. For this, each of the upper and lower electrodes 10 and 20 may have thicknesses different from each other for each region. However, the lower electrode 20 in the third region R3 may include a plurality of through-holes h21 to h2n instead of grooves b1 to bn, so as to perform the sound wave reception function.

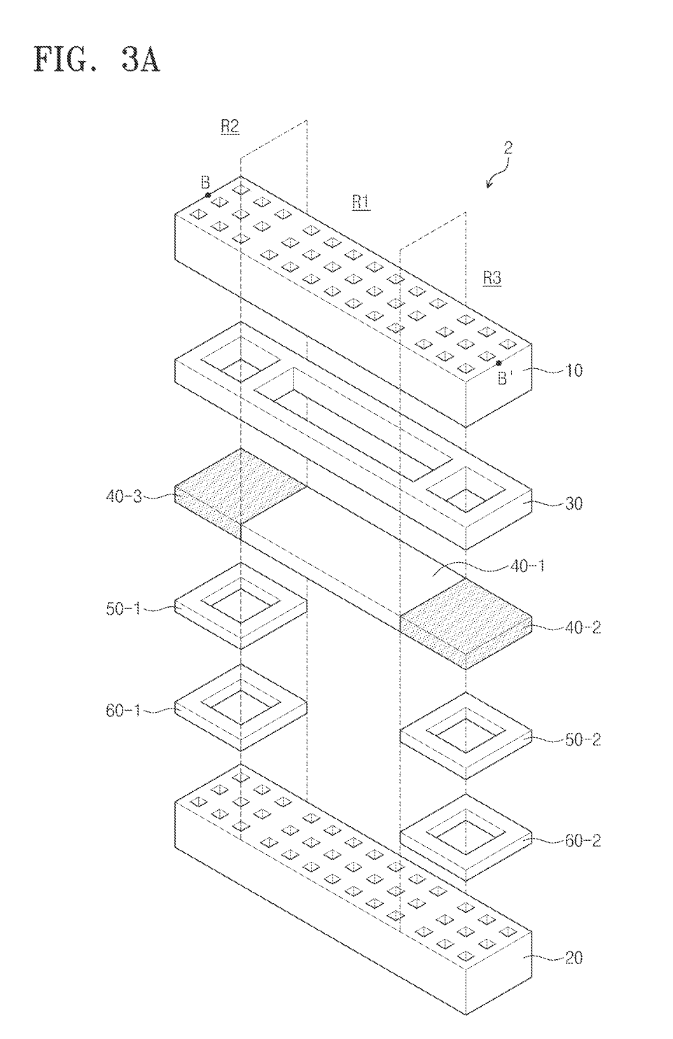

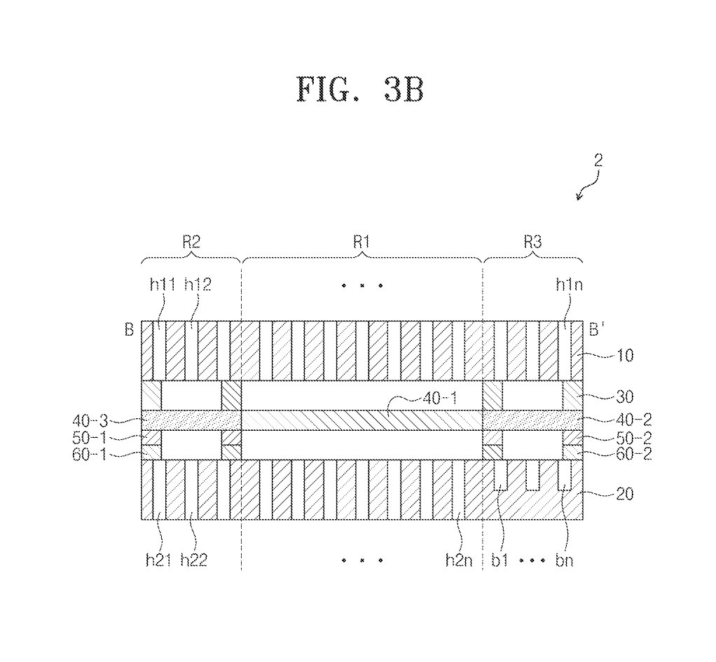

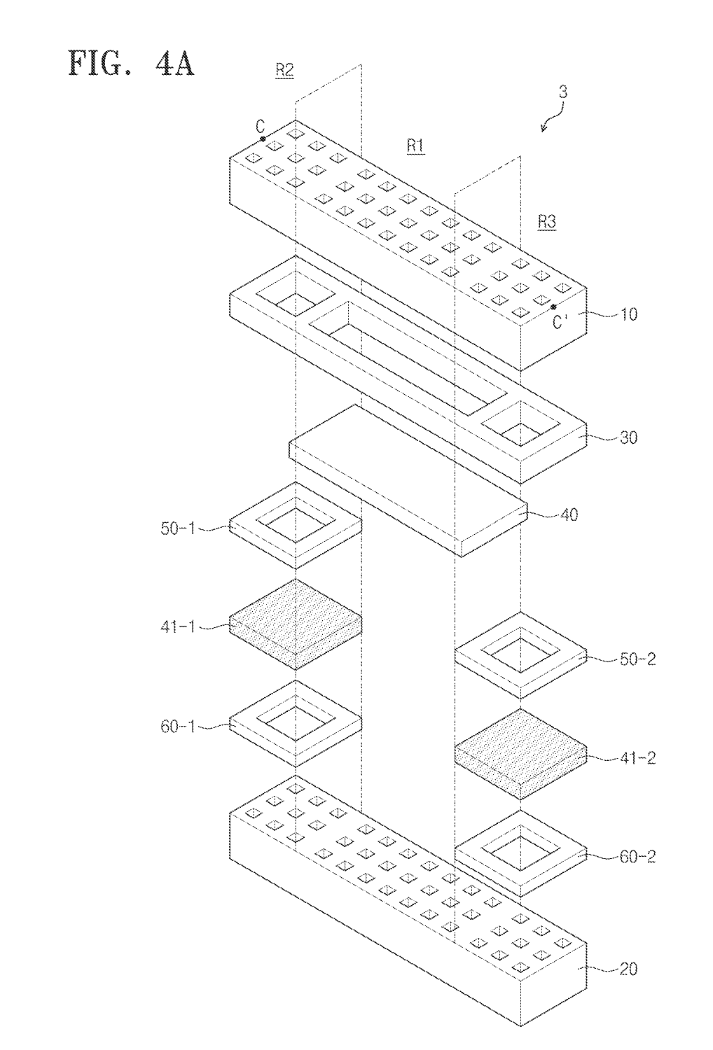

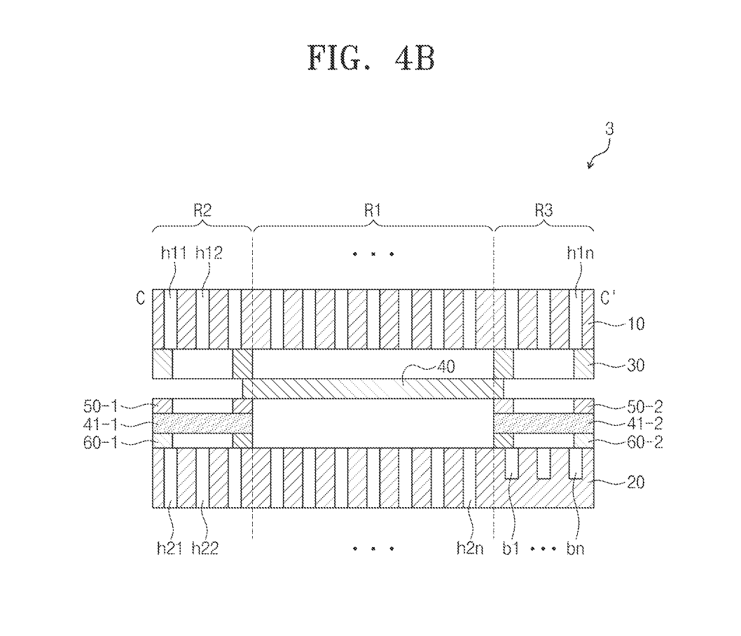

In this manner, the all-in-one device 1 may have a structure in which the vibration spaces of the first diaphragm 40 are differently defined for each region, so as to perform different functions for each region. In addition, the first diaphragm 40 may be coated differently for each region (see FIGS. 3A and 3B) or a plurality of diaphragms having different material properties may be used (see FIGS. 4A and 4B), and thus an all-in-one device having different functions for each region may be realized. Detailed descriptions with respect to the all-in-one devices illustrated in FIGS. 3A to 4B will be described later.

FIG. 2 is a schematic block diagram of a driving part for driving the all-in-one device of FIGS. 1A and 1B.

Referring to FIG. 2, the all-in-one device 1 may include a driving unit 100 that has a voltage applying unit 70, a control unit 80, and a detection unit 90.

The control unit 80 may output control signals CS1 to CS3 for activating functions of the all-in-one device 1 for each region. The control unit 80 may output the control signals CS1 to CS3 to the voltage applying unit 70 and the detection unit 90. The voltage applying unit 70 and the detection unit 90 may operate in response to the received control signals CS1 to CS3.

The control unit 80 may output a first control signal CS1 for activating an audio output function of the first region R1. The control unit 80 may receive an audio signal AS from an external source and may output the first control signal CS1 corresponding to the received audio signal AS. The voltage applying unit 70 may apply a voltage to the upper and lower electrodes 10 and 20 and at least one of the diaphragm electrodes 50-1 and 50-2 in response to the received first control signal CS1.

The voltage applying unit 70 may apply voltages having polarities different from each other to the upper and lower electrodes, and may apply a bias voltage to the diaphragm electrodes 50-1 and 50-2 in response to the first control signal CS1. In this case, the bias voltage may be applied to the first diaphragm 40 that is in contact with the diaphragm electrodes 50-1 and 50-2. Since voltages having polarities different from each other are applied into the upper and lower electrodes 10 and 20, electrostatic force may be applied to the first diaphragm 40 disposed between the upper and lower electrodes 10 and 20. As a result, the first diaphragm 40 may vibrate in the vertical direction of FIG. 2.

For example, a positive voltage may be applied to the upper electrode 10, and a negative voltage may be applied to the lower electrode 20. Since a positive bias voltage is applied to the first diaphragm 40, a repulsive force may be generated between the upper electrode 10 and the first diaphragm 40. Also, an attractive force may be generated between the lower electrode and the first diaphragm 40. Thus, the first diaphragm 40 may move toward the lower electrode 20.

On the contrary, when a positive voltage is applied to the lower electrode 20, and a negative voltage is applied to the upper electrode 10, the first diaphragm 40 may move toward the upper electrode 10.

In this manner, the first diaphragm 40 may be made to repeatedly move repeatedly and vertically toward either the upper electrode 10 or the lower electrode 20, thereby generating sound waves.

Since the first region R1 provides sufficient clearance for the first diaphragm 40 to vibrate, the first diaphragm 40 in the first region R1 may vibrate in the vertical direction at sufficient magnitude to generate sound waves having audible frequency and amplitude. The sound waves generated by the vibration of the first diaphragm 40 may be output through the through-holes h11 to h1n and h21 to h2n defined in the upper and lower electrodes 10 and 20. The first diaphragm 40 in the second and third regions R2 and R3 may vibrate according to the same potential difference as above. However, since there is insufficient clearance, the first diaphragm 40 does not generate audible sound from these regions.

The first diaphragm 40 in the first region R1 may generate waves having various frequencies according to a difference in potential between the upper and lower electrodes 10 and 20. For example, the first diaphragm 40 may generate sound waves and/or ultrasonic waves according to the difference in potential between the upper and lower electrodes 10 and 20. Thus, the voltage applying unit 70 may adjust the voltages respectively applied to the upper and lower electrodes 10 and 20 for each function, so as to generate both sound waves and ultrasonic waves through the first diaphragm 40 of the first region R1.

The control unit 80 may output a second control signal CS2 to the voltage applying unit 70 and the detection unit 90, for activating the audio reception function of the second region R2. The voltage applying unit 70 may apply voltages to the diaphragm electrode 50-1 and the lower electrode 20 in the second region R2 in response to the second control signal CS2. The detection unit 90 may be activated in response to the second control signal CS2.

When the sound waves are transmitted to the first diaphragm 40 through the through-holes h11 to h1n defined in the second region R2, the first diaphragm 40 may be induced to vibrate. The distance from the first diaphragm 40 to the lower electrode 20 may be changed by the vibration of the first diaphragm 40. The voltages are applied to the first diaphragm 40 and the lower electrode 20. Air having an insulation property is present between the first diaphragm 40 and the lower electrode 20. Thus, the change in distance from the first diaphragm 40 to the lower electrode 20 may cause a change in capacitance between the first diaphragm 40 and the lower electrode 20.

The detection unit 90 may be connected to the lower electrode 20 to detect the change in capacitance between the first diaphragm 40 and the lower electrode 20. The detection unit 90 may detect the degree of change of the capacitance, and generate an electric signal CS21 corresponding to the degree of change of this capacitance. The detection unit 90 may transmit the generated electric signal CS21 to the control unit 80.

For example, the detection unit 90 may include an operational amplifier having high input impedance. A small amount of electric charge may exist in the lower electrode 20. The electric charge may vary together with the change of capacitance between the lower electrode 20 and the first diaphragm 40. The small amount of electric charge may move to the operational amplifier of the detection unit 90 to be amplified and output. The electric charge amplified through the operational amplifier may be transmitted to the control unit 80 as the electric signal CS21.

The control unit 80 may output a third control signal CS3 to the voltage applying unit 70 and the detection unit 90, for activating the ultrasonic sensor function in the first and third regions R1 and R2. The voltage applying unit 70 may apply voltages to the diaphragm electrode 50-2 and the upper electrode 10 and/or the lower electrode 20 in response to the third control signal CS3. The detection unit 90 may be activated in response to the third control signal CS3.

The voltage applying unit 70 may apply voltages different from each other to the upper and lower electrodes 10 and 20 and may apply a bias voltage to the diaphragm electrode 50-2 in response to the third control signal CS3 to vibrate the first diaphragm 40 connected to the diaphragm electrode 50-2 electrically, thereby generating ultrasonic waves. Or, the voltage applying unit 70 may repeatedly apply voltage having the same polarity or voltages having polarities different from each other to the diaphragm electrode 50-2 and the lower electrode 20 in the third region R3 to vibrate the first diaphragm 40 connected to the diaphragm electrode 50-2 electrically, thereby generating ultrasonic waves.

The sound waves generated by the vibration of the first diaphragm 40 may be output through the through-holes h11 to h1n of the upper electrode 10. When an obstacle blocks these ultrasonic waves, the ultrasonic waves may be reflected by the obstacle back inside the all-in-one device 1 through the through-holes h11 to h1n of the upper electrode 10.

The ultrasonic waves reflected back through the first and second regions R1 and R2 of the all-in-one device 1 may pass through the lower electrode 20 and thus be discharged again through the through-holes h21 to h2n defined in the lower electrode 20 of the first and second regions R1 and R2. The ultrasonic waves reflected back through the third region R3 of the all-in-one device 1 may be re-reflected by the grooves b1 to bn defined in the third region R2, and thus may be transmitted to the first diaphragm 40.

The first diaphragm 40 may vibrate by these reflected ultrasonic waves. The capacitance between the first diaphragm 40 and the lower electrode 20 may vary by the vibration of the first diaphragm 40.

The detection unit 90 may detect the degree of this capacitance change, and generate an electric signal CS31 corresponding to this change. The detection unit 90 may detect the degree, time, and speed of the change of the capacitance to generate an electric signal CS31 corresponding to the change of the capacitance. The detection unit 90 may transmit the generated electric signal CS31 to the control unit 80. A method of detecting the change in capacitance by the detection unit 90 is the same as that described above.

The control unit 80 may detect a distance from the control unit 80 to the obstacle, as well as a size, thickness, width, and movement of the obstacle, from the electric signal CS31 transmitted from the detection unit 90. For example, the control unit 80 may detect that the distance from the control unit 80 to the obstacle is small and/or the size, thickness, width of the obstacle is large when the control unit 80 detects that the speed of the change of the capacitance is greater than a predetermined speed through the electric signal CS31. On the contrary, the control unit 80 may detect that the distance from the control unit 80 to the obstacle is large and/or the size, thickness, width of the obstacle is small when the control unit 80 detects that the speed of the change of the capacitance is smaller than the predetermined speed through the electric signal CS31. However, embodiments of the invention are not be limited to the above-described embodiments.

The above-described driving unit 100 may be equally applied to all-in-one devices according to other embodiments that will be described later.

FIG. 3A is a perspective view of an all-in-one device according to a second embodiment. FIG. 3B is a cross-sectional view of the all-in-one device of FIG. 3A. In the current embodiment, components similar to those of the first embodiment are described by using the same reference numerals, and corresponding detailed descriptions with reference to FIGS. 1A to 2 may be equally applied to the current embodiment.

Referring to FIGS. 3A and 3B, an all-in-one device 2 may be partitioned into first to third regions R1 to R3.

Each of the first to third regions R1 to R3 may include an upper electrode 10, a lower electrode 20 facing the upper electrode 10, a first diaphragm 40-1 to 40-3 disposed between the upper and lower electrodes 10 and 20, and a first space 30 disposed between the first diaphragm 40-1 to 40-3 and the upper electrode 10. The upper electrode 10 may include a plurality of through-holes h11 to h1n, and the lower electrode 20 may include a plurality of through-holes h21 to h2n and/or a plurality of grooves b1 to bn.

The second and third regions R2 and R3 may further include a plurality of second spacers 60-1 and 60-2 and a plurality of diaphragm electrodes 50-1 and 50-2 respectively corresponding to the second spacers 60-1 and 60-2. Also, the second spacers 60-1 and 60-2 may be disposed on both ends of the lower electrode 20.

The first region R1 may perform a sound wave and ultrasonic wave output function, and the second region R2 may perform a sound wave reception function. Also, the third region R3 may perform an ultrasonic wave reception function. In this case, the upper electrode 10 in the first to third regions R1 to R3 and the lower electrode 20 in the first and second regions R1 and R2 may include through-holes h11 to h1n and h21 to h2n as shown. The lower electrode 20 in the third region R3 may instead include grooves b1 to bn.

According to another embodiment, the first region R1 may perform a sound wave output function, and each of the second and third regions R2 and R3 may perform a sound wave reception function. In this case, the upper and lower electrodes 10 and 20 have through-holes formed in each of the first to third regions R1 to R3.

In the all-in-one device 2 according to the current embodiment, each of the upper and lower electrodes 10 and 20 may have a uniform thickness in all regions, unlike the all-in-one device 1 according to the first embodiment. However, the all-in-one device 2 according to the current embodiment may have first diaphragms 40-1 to 40-3 having material properties different from each other for each region.

For example, a first part 40-1 of the first diaphragms 40-1 to 40-3 included in the first region R1 may have a material property different from that of each of second parts 40-2 and 40-3 included in the second and third regions R2 and R3. Thus, the first diaphragms 40-1 to 40-3 may be coated with materials different from each other for each part. For example, the second parts 40-2 and 40-3 may be coated with metal or diamond-shaped carbon.

Since the second parts 40-2 and 40-3 are coated, each of the second parts 40-2 and 40-3 may have an amplitude in vibration that is less than that of the first part 40-1, for vibrations induced by the same potential difference of the upper and lower electrodes 10 and 20. Thus, the first diaphragms 40-1 to 40-3 may perform functions different from each other for each part. In detail, the uncoated first part 40-1 may perform a sound wave or ultrasonic wave output function, and each of the coated second parts 40-2 and 40-3 may perform a sound wave or ultrasonic wave reception function.

FIG. 4A is a perspective view of an all-in-one device according to a third embodiment. FIG. 4B is a cross-sectional view of the all-in-one device of FIG. 4A. In the current embodiment, structures similar to those of the first and second embodiments are described by using the same reference numerals, and detailed descriptions with reference to FIGS. 1A to 2 may be equally applied to the current embodiment.

Referring to FIGS. 4A and 4B, an all-in-one device 3 may be partitioned into first to third regions R1 to R3.

Each of the first to third regions R1 to R3 may include an upper electrode 10, a lower electrode 20 facing the upper electrode 10, a first diaphragm 40 disposed between the upper and lower electrodes 10 and 20, and a first spacer 30 disposed between the first diaphragm 40 and the upper electrode 10. The upper electrode 10 may include a plurality of through-holes h11 to h1n, and the lower electrode 20 may include a plurality of through-holes h21 to h2n and a plurality of grooves b1 to bn.

The second and third regions R2 and R3 may further include a plurality of second spacers 60-1 and 60-2 and a plurality of diaphragm electrodes 50-1 and 50-2 respectively corresponding to the second spacers 60-1 and 60-2. Also, the second spacers 60-1 and 60-2 may be disposed on both ends of the lower electrode 20. The second and third regions R2 and R3 may further include second diaphragms 41-1 and 41-2 respectively disposed between the second spacers 60-1 and 60-2 and the diaphragm electrodes 50-1 and 50-2. The second diaphragms 41-1 and 41-2 may be disposed on the second spacers 60-1 and 60-2 to respectively correspond to the second spacers 60-1 and 60-2.

The first region R1 may perform a sound wave and ultrasonic wave output function, and the second region R2 may perform a sound wave reception function. Also, the third region R3 may perform an ultrasonic wave reception function. In this case, the upper electrode 10 in the first to third regions R1 to R3 and the lower electrode 20 in the first and second regions R1 and R2 may include through-holes h11 to h1n and h21 to h2n. The lower electrode 20 in the third region R3 may instead include grooves b1 to bn.

According to another embodiment, the first region R1 may perform a sound wave output function, and each of the second and third regions R2 and R3 may perform a sound wave reception function. In this case, the upper and lower electrodes 10 and 20 in the first to third regions R1 to R3 may each include through-holes, rather than region R3 having grooves b1 to bn.

The all-in-one device 3 according to the current embodiment may further include second diaphragms 41-1 and 41-2 in addition to the first diaphragm 40, unlike the all-in-one devices 1 and 2 of the first and second embodiments. Here, the first diaphragm 40 and the second diaphragms 41-1 and 41-2 may have material properties different from each other. For example, the first diaphragm 40 may have an elastic coefficient less than that of each of the second diaphragms 41-1 and 41-2. As a result, the same potential difference between the upper and lower electrode 10 and 20 may induce vibration of greater amplitude in the first diaphragm 40 than that in each of the second diaphragms 41-1 and 41-2. Thus, the first diaphragm 40 may perform a sound wave or ultrasonic wave output function, and each of the second diaphragms 41-1 and 41-2 may perform a sound wave or ultrasonic wave reception function.

Since the first and second diaphragms 40 and 41-1 and 41-2 have functions different from each other, the first diaphragm 40 and the second diaphragms 41-1 and 41-2 may be disposed so that the first diaphragm 40 does not substantially overlap the second diaphragms 41-1 and 41-2 in plan view. Thus, for example, the first diaphragm 40 may be substantially disposed only in the first region R1 of the all-in-one device 3, and the second diaphragms 41-1 and 41-2 may be substantially disposed only in the second and third regions R2 and R3, respectively. Both ends of the first diaphragm 40 may be disposed on the diaphragm electrodes 50-1 and 50-2. Thus, the first diaphragm 40 slightly overlaps both diaphragm electrodes 50-1 and 50-2. The first diaphragm 40 may be disposed on the diaphragm electrodes 50-1 and 50-2 in a bridge shape connecting the diaphragm electrodes 50-1 and 50-2 to each other.

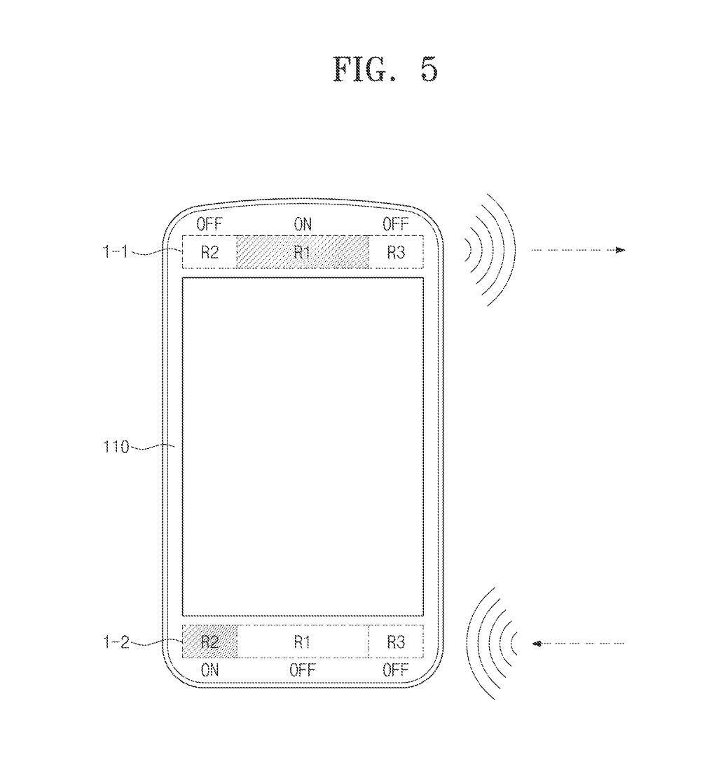

FIG. 5 is a front view of an electronic device including an exemplary all-in-one device of embodiments of the invention. For convenience of description, FIG. 5 will be described with reference to an electronic device 110 including all-in-one device 1 of the first embodiment. However, embodiments of the invention are not limited to use of electronic device 110. For example, one of ordinary skill in the art will observe that principles described with respect to FIG. 5 can be equally applied to an electronic device including each of the all-in-one devices 2 and 3 according to each of the second and third embodiments.

Referring to FIG. 5, electronic device 110 may include a plurality of all-in-one devices 1 and a driving part 100 for driving the all-in-one devices 1. The plurality of all-in-one devices 1 may include a first all-in-one device 1-1 and a second all-in-one device 1-2. The first all-in-one device 1-1 may be disposed at one side of the electronic device 110, and the second all-in-one device 1-2 may be disposed at an opposite side of the electronic device 110, although positioning at any suitable sides or locations of the device 110 is contemplated.

The first and second all-in-one devices 1-1 and 1-2 may be controlled to perform the same function, or functions different from each other, by the driving part 100.

According to one embodiment, each of the first and second all-in-one devices 1-1 and 1-2 may be controlled to perform a speaker or receiver function. The driving part 100 may activate the first region R1 of each of the first and second all-in-one devices 1-1 and 1-2 to allow each of the first and second all-in-one devices 1-1 and 1-2 to perform its speaker or receiver function. More specifically, the driving part 100 may adjust a potential difference applied to the first region R1 of each of the first and second all-in-one devices 1-1 and 1-2 so as to adjust the volume of sound waves generated/received, thereby allowing each of the all-in-one devices 1-1 and 1-2 to perform the speaker or receiver function. In this case, the second and third regions R2 and R3 of each of the all-in-one devices 1-1 and 1-2 may not be activated, i.e. only the regions R1 of devices 1-1 and 1-2 are activated.

When each of the first and second all-in-one devices 1-1 and 1-2 performs a speaker function, the electronic device 110 may provide stereo sound.

According to another embodiment, the first all-in-one device 1-1 may be controlled to perform a receiver function, and the second all-in-one device 1-2 may be controlled to perform a microphone function. In this case, the driving part 100 may activate the first region R1 of the first all-in-one device 1-1 and the second region R2 of the second all-in-one device 1-2. Thus, the electronic device 110 may provide a call function to a user.

The driving part 100 may detect a position or orientation of the electronic device 110 to determine which all-in-one device to use. For example, the driving part 100 may detect or determine that the device 110 is oriented upright, so that the first all-in-one device 1-1 is positioned above the second all-in-one device 1-2. The driving part 100 may detect the position or orientation of the electronic device 110 by using a gravity sensor, a proximity sensor, a gyro sensor, and so on.

In this case, the driving part 100 may control the devices 1-1, 1-2 so that the first all-in-one device 1-1 performs a receiver function, and the second all-in-one device 1-2 performs a microphone function. In detail, the driving part 100 may activate the first region R1 of the first all-in-one device 1-1 so that the first all-in-one device 1-1 performs the receiver function, and may activate the second region R2 of the second all-in-one device 1-2 so that the second all-in-one device 1-2 performs the microphone function. As a result, the user may make a call regardless of the position of the electronic device 110.

According to another embodiment, each of the first and second all-in-one devices 1-1 and 1-2 may be controlled to perform an ultrasonic wave function. In this case, the driving part 100 may activate the first and third regions R1 and R3 of each of the first and second all-in-one devices 1-1 and 1-2. Here, the second region R2 of each of the all-in-one devices 1-1 and 1-2 may not be activated. Thus, in known manner, the electronic device 100 may more accurately sense a distance from the electronic device 100 to an object as well as a thickness, size, and movement of the object.

Further, the functions of the all-in-one devices of embodiments of the invention may be selectively controlled according to purpose of use, usage, and use environment of the electronic device 110 and not be limited to the above-described embodiments.

The all-in-one devices according to an embodiment of the inventive concept may be able to function as a speaker, microphone, and ultrasonic sensor. Therefore, the size of electronic devices provided with the all-in-one device may be reduced when compared to more conventional electronic devices that have separate components for each such function.

For convenience of description, although the present disclosure has been separately described for each of the drawings, the embodiments described with reference to the drawings may be used under various combinations and changes to realize a new embodiment. Also, the all-in-one device is not limited and applied to the constitutions and methods of the above-described embodiments, and portions or all of the above-described embodiments can be selectively combined and constructed so that various modifications are possible. Thus, different features of the various embodiments, disclosed or otherwise understood, can be mixed and matched in any manner to produce further embodiments within the scope of the invention.

Although the preferred embodiments have been described, the inventive concept is not limited to the specific embodiment described above, and it is cleat to those in the art that they may be changed and modified variously within a spirit and a scope of the appended claims of the inventive concept. It will also be apparent that such variations of the inventive concept are not to be understood individually or separately from the technical scope or spirit of the inventive concept.

What is claimed is:

1. An all-in-one device having first, second and third regions, the all-in-one device comprising:
an upper electrode disposed in each of the first, second and third regions;
a lower electrode disposed in each of the first, second and third regions to face the upper electrode;
a first diaphragm disposed in each of the first, second and third regions and positioned between the upper electrode and the lower electrode;
a first spacer disposed in at least two of the first, second and third regions to electrically insulate the first diaphragm from the upper electrode;
second spacers respectively disposed in the second and third regions, and each disposed on the lower electrode; and
diaphragm electrodes respectively disposed in the second and third regions, and disposed between the respective second spacers and the first diaphragm.

2. The all-in-one device of claim 1, wherein a first distance from the first diaphragm to the upper or lower electrode in the first region is greater than a second distance from the first diaphragm to the upper or lower electrode in the second or third region.

3. The all-in-one device of claim 2, wherein a thickness of the upper or lower electrode in the first region is less than its thickness in the second and third regions.

4. The all-in-one device of claim 3, wherein the first region is a region configured to generate sound waves, and
each of the second and third regions is a region configured to generate corresponding electrical signals from received sound waves.

5. The all-in-one device of claim 4, wherein each of the upper and lower electrodes comprises a plurality of through-holes in each of its first through third regions, the through-holes configured for receiving or emitting the sound waves.

6. The all-in-one device of claim 3, wherein:
the first region is configured to generate both sound waves and ultrasonic waves,
the second region is configured to generate corresponding electrical signals from received sound waves, and
the third region is configured to generate corresponding electrical signals from received ultrasonic waves.

7. The all-in-one device of claim 6, wherein the upper electrode in the first to third region comprises a first plurality of through-holes configured to pass at least one of sound waves and ultrasonic waves therethrough.

8. The all-in-one device of claim 7, wherein the lower electrode in the first and second regions comprises a second plurality of through-holes, and
the lower electrode in the third region comprises a plurality of grooves.

9. The all-in-one device of claim 1, wherein the first diaphragm is partitioned into a first part in the first region and a second part in the second and third regions, and
the first and second parts comprise different materials.

10. The all-in-one device of claim 9, wherein the second part is coated with diamond-shaped carbon or metal.

11. The all-in-one device of claim 10, wherein the first region is configured to generate sound waves, and
each of the second and third regions is configured to generate corresponding electrical signals from received sound waves.

12. The all-in-one device of claim 11, wherein each of the upper and lower electrodes comprises a plurality of through-holes in each of the first through third regions, the through-holes sized for passing sound waves therethrough.

13. The all-in-one device of claim 10, wherein:
the first region is configured to generate both sound waves and ultrasonic waves,
the second region is configured to generate corresponding electrical signals from received sound waves, and
the third region is configured to generate corresponding electrical signals from received ultrasonic waves.

14. The all-in-one device of claim 13, wherein the upper electrode comprises a plurality of through-holes in each of the first through third regions, the through-holes sized for passing sound waves and ultrasonic waves therethrough.

15. The all-in-one device of claim 14, wherein the lower electrode comprises a plurality of through-holes in the first and second regions, and
the lower electrode comprises a plurality of grooves formed in the third region.

16. The all-in-one device of claim 1, further comprising second diaphragms disposed on the second spacers and respectively disposed in the second and third regions.

17. The all-in-one device of claim 16, wherein the first diaphragm has opposing ends respectively disposed on the diaphragm electrodes.

18. The all-in-one device of claim 17, wherein a first elastic coefficient of the first diaphragm is different from a second elastic coefficient of the second diaphragms.

19. The all-in-one device of claim 18, wherein the first elastic coefficient is less than the second elastic coefficient.

20. The all-in-one device of claim 19, wherein the lower electrode comprises a second plurality of through-holes positioned in each of the first through third regions, and
the lower electrode in the third region comprises a plurality of grooves.
